(19) United States
(12) Patent Application Publication
(10) Pub. No.: US 2007/0271115 A1
(43) Pub. Date: Nov. 22, 2007

(54) Medical Device Which Can Be Operated With Various Operating Settings, In Particular Patient Monitor

(75) Inventors: Heribert Baldus, Aachen (DE); Karin Klabunde, Bochum (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/596,570

(22) PCT Filed: Dec. 13, 2004
(86) PCT No.: PCT/IB04/52770

§ 371 Date: Feb. 22, 2007

(30) Foreign Application Priority Data
Dec. 19, 2003 (EP) 03104812.7

(51) Int. Cl. G06Q 50/00

(52) U.S. Cl. 705/2

(57) ABSTRACT

System for use in a hospital, comprising a configuration management system (KMS) and a location system, where a current operating mode of medical devices in signal connection with the configuration management system is determined by the KMS from predetermined operating settings stored in a memory.

The invention relates to a device used for medical purposes. This medical device can be operated with various operating settings.

U.S. Pat. No. 5,640,953 discloses a medical system with a portable monitor. The monitor is transportable and operated with different settings at different locations. At each of the different locations a docking station is provided in which are stored the settings with which the monitor is to be operated at this location. On connection of the monitor to the docking station, the monitor receives the settings given by the docking station. The connection of docking station and monitor can be wireless.

The invention is based on the object of providing a medical device and a process for operation of a medical device which can be used comfortably adapted to the requirement situation.

The object of the invention is solved by a medical device as claimed in claim 1 and the process as claimed in claim 8.

By providing a configuration management system, referred to below as KMS, in which the basic settings are stored and where this KMS is in signal connection with a medical device, it is possible to operate the medical device adapted automatically to current requirements. Stored in a memory in the KMS are base settings allocated to signal combinations. A signal combination can also comprise just one signal. Preferably the signal combinations comprise different types of signals such as for example location information, staff information and patient information.

As a result it is possible to specify a predetermined operation of the medical device in accordance with the corresponding signal combination or signal according to the associated base settings. Thus automatic adaptation of the medical device is possible without manual activity being required.

The base setting pre-specified by the KMS can be adapted continuously or at predetermined time intervals to the actual usage situation of the medical device. The usage situation is detected from the signals supplied to the KMS.

It can be provided, as a function of the determined location of the medical device, to provide automatic configuration or adaptation of configuration to the new situation of the medical device by the KMS. For example different zones in a hospital can be characterized by different signals emitted. On a change of zone e.g. from intensive care unit to another zone e.g. nursing ward, on first reception of a signal characterizing this zone a base setting allocated to this zone is automatically used for operation of the device. For example a change in the assumed base setting can result in a change in the details shown or the measurement accuracy of the medical device.

It can also be provided that a detected modified location information must remain present for a predetermined period before the medical device can be adapted, according to the new location knowledge, to a base setting allocated to this location. This avoids continuous quick changes between different base settings in the transition zones.

In one embodiment it can be provided that person identification signals received are used for operation of the medical device. It can also be provided that selection of the base setting assumed for operation of the medical device is predetermined as a function of both location information and person identification received. The person identification can take into account the presence of a doctor or nurse. It is normally to be assumed that the doctor requires detailed information.

If the medical device for example is a patient monitor, it can be provided that on detection of the presence of a doctor in the vicinity of the device, the details shown on the monitor are increased and on detection of the presence of a nurse fewer details are shown. A pre-specified order of priority can be provided so that the detected person identification with the highest priority is always used for specifying the base setting of the medical device.

It can also be provided that if person identification is not present for a predetermined period, the medical device switches to a standby mode as the base setting.

If the medical device is a sensor, the operating mode of the sensor can be predetermined by a base setting.

For energy saving for example the display of measurement values can be reduced to periods of presence of medical staff.

In a further embodiment it can be provided that the signals received from the configuration management system are patient information. Thus the base setting of the medical device can take into account illness and patient condition. Thus if an emergency is detected by the configuration management system, a base setting for operation of the medical device can be used in which the medical system is operated at maximum sensitivity. Control of further medical devices can also be provided. For example further sensors and measurement devices allocated to the same patient can be activated by KMS.

It can be provided to pre-specify the base setting used as a function of patient information and location information. It can furthermore be provided that the base setting used is predetermined as a function of the patient information and detected staff identification.

It can also be provided that the base setting is predetermined as a function of known location information and known staff information and known patient information.

The configuration management system can be provided in the medical device.

Furthermore the KMS can be arranged centrally, separated from the medical device. It can be provided that a central KMS controls a multiplicity of medical devices.

It can be provided that the KMS is fitted with a rewritable memory. In this memory can be stored individual modifications of the base settings so that a variant can be stored according to personal preference, e.g. by a doctor connected with his ID. On detection of the doctor ID these modified base settings can automatically be retrieved by the medical device. Furthermore individual base settings from other aspects can be stored which are automatically retrieved on occurrence of the corresponding situation.

It can be provided that the KMS is fitted with different receiver units matched to different frequencies.

If the KMS is integrated in the medical device, the KMS can receive signals from various networks via the various receiver units. The different networks can have different ranges.

It can be provided to transmit patient data over a range of 2-3 meters and person identification signals over a range of up to 10 meters, preferably up to 5 meters.

In one embodiment location signals and further additional information can be transferred over ranges of 30 meters.

Further advantageous measures are described in the claims.

The invention will be further described with reference to examples of embodiments shown in the drawings, to which however the invention is not restricted. These show:

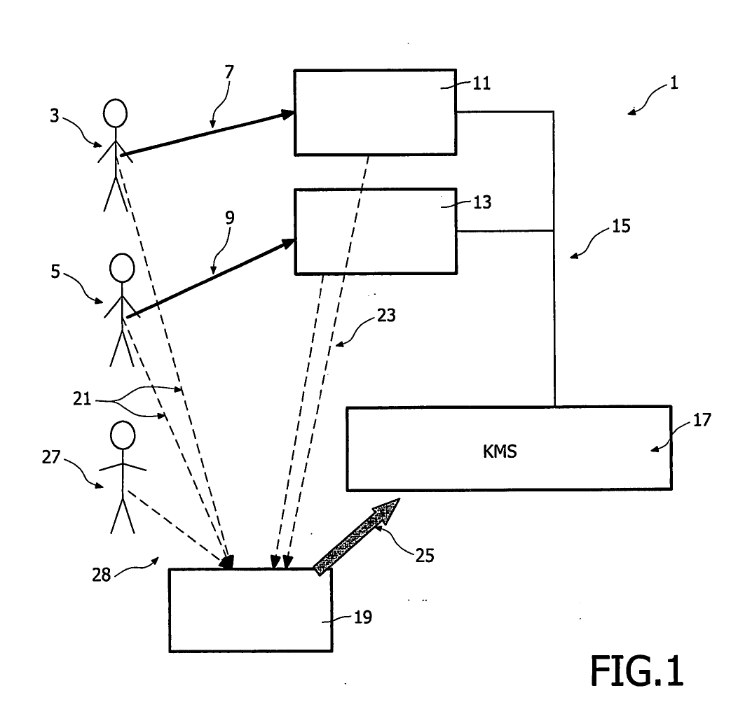

FIG. 1 a diagrammatic view of the total system with central location system;

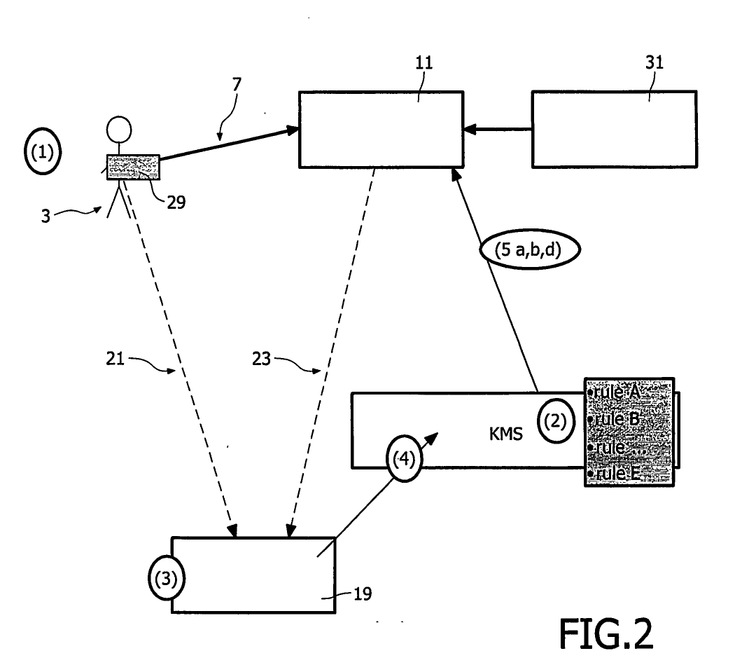

FIG. 2 a view with a monitoring device;

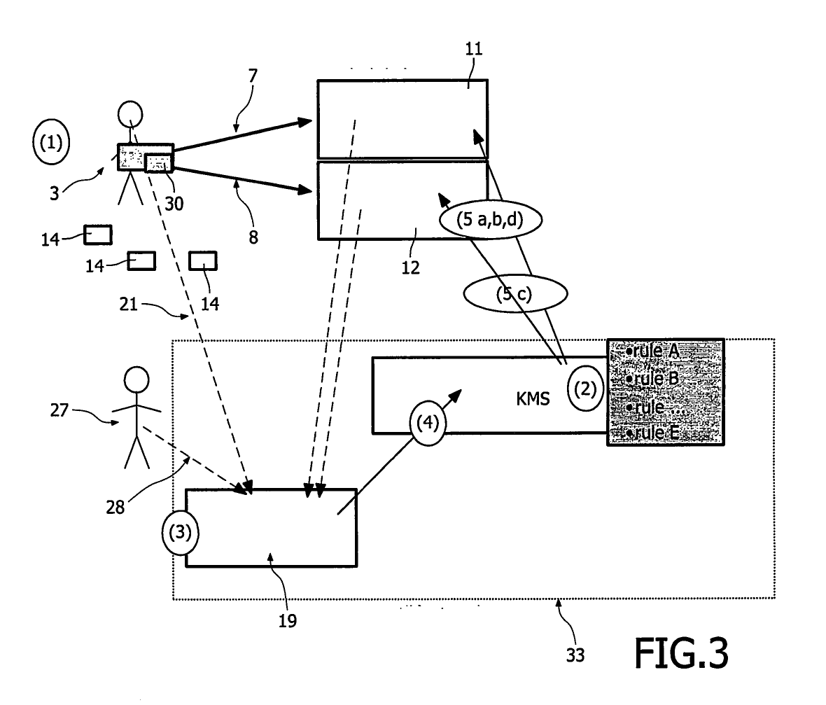

FIG. 3 a system with two monitoring devices allocated to one patient;

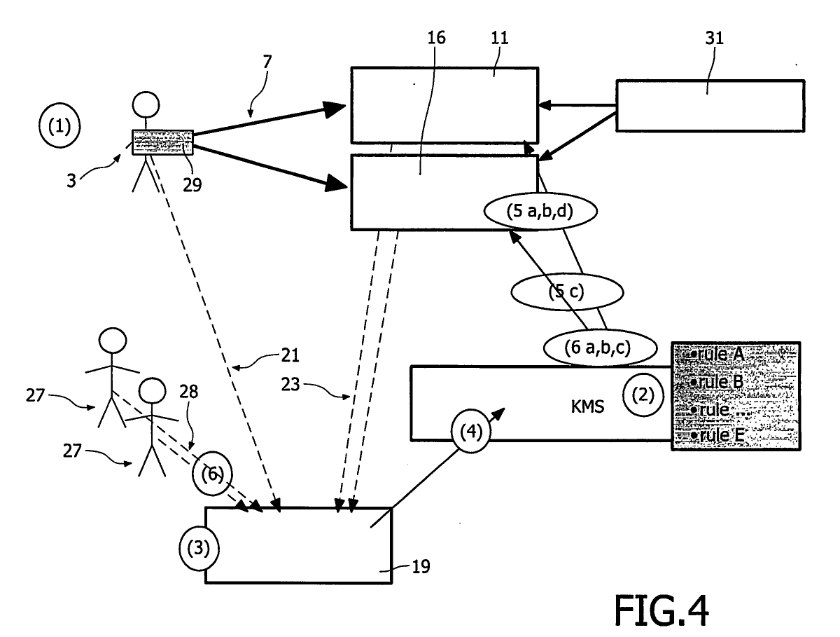

FIG. 4 a system with monitoring devices allocated to the patient, the operating mode of which devices is dependent on the presence of hospital staff;

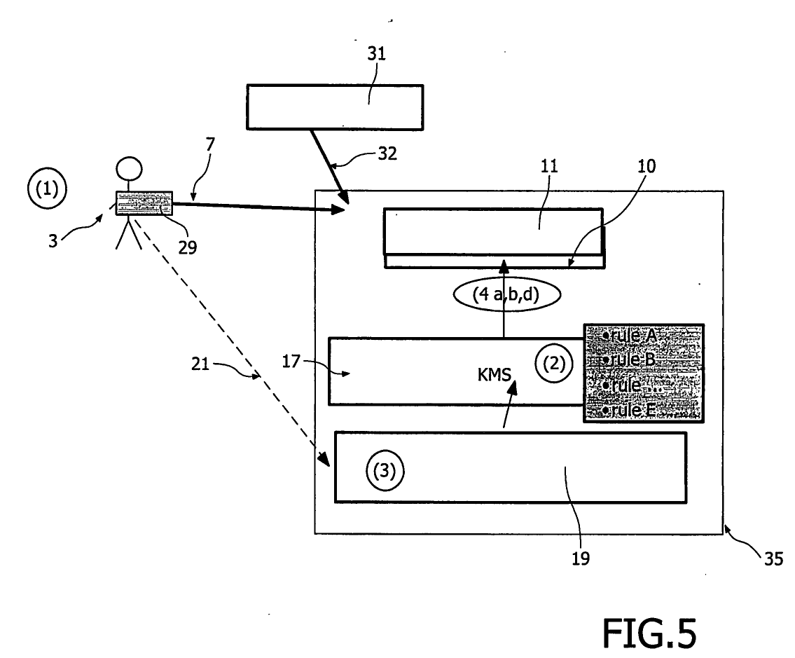

FIG. 5 a view of a total system with decentrally arranged configuration management system (KMS) and location system;

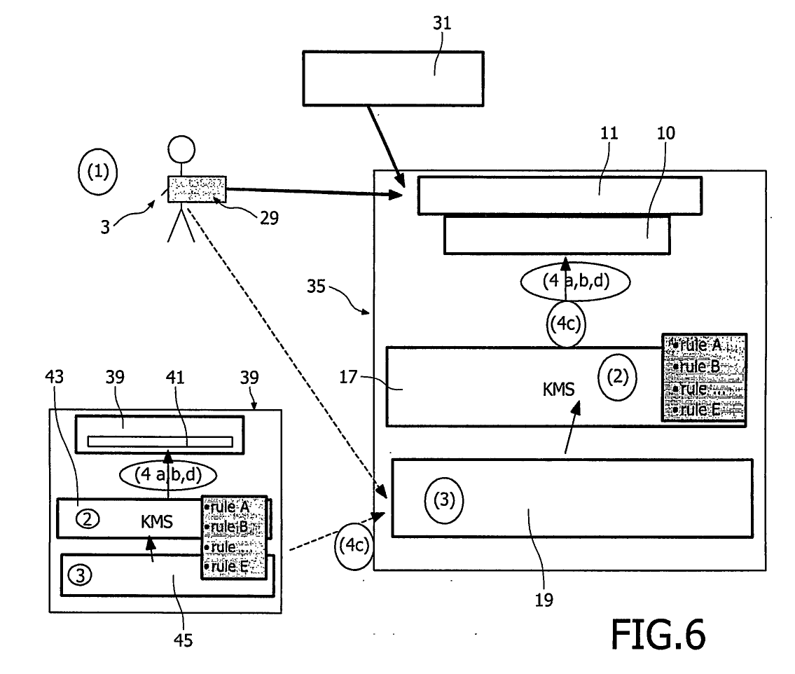

FIG. 6 a system with two decentral units;

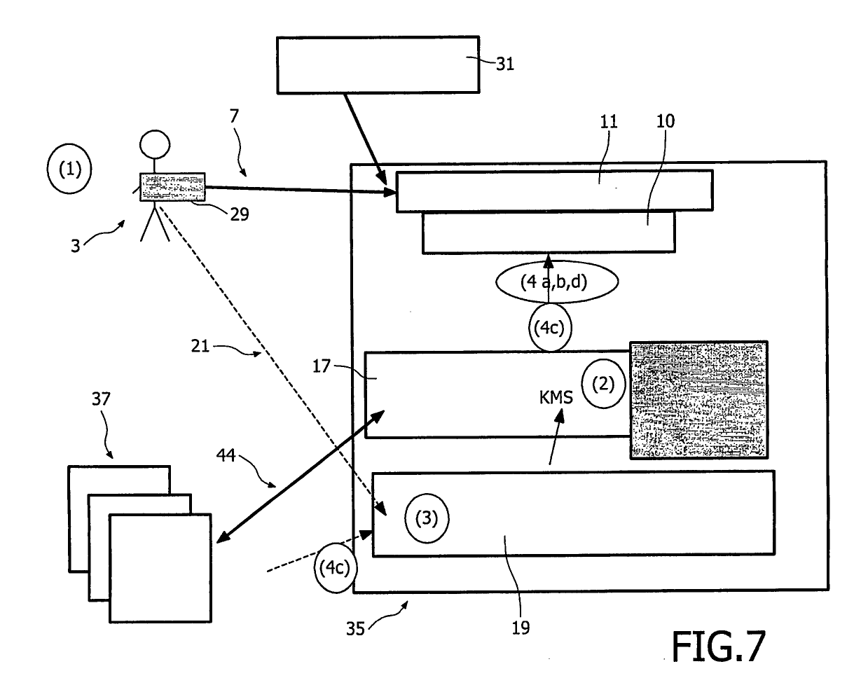

FIG. 7 a system with several decentrally arranged units;

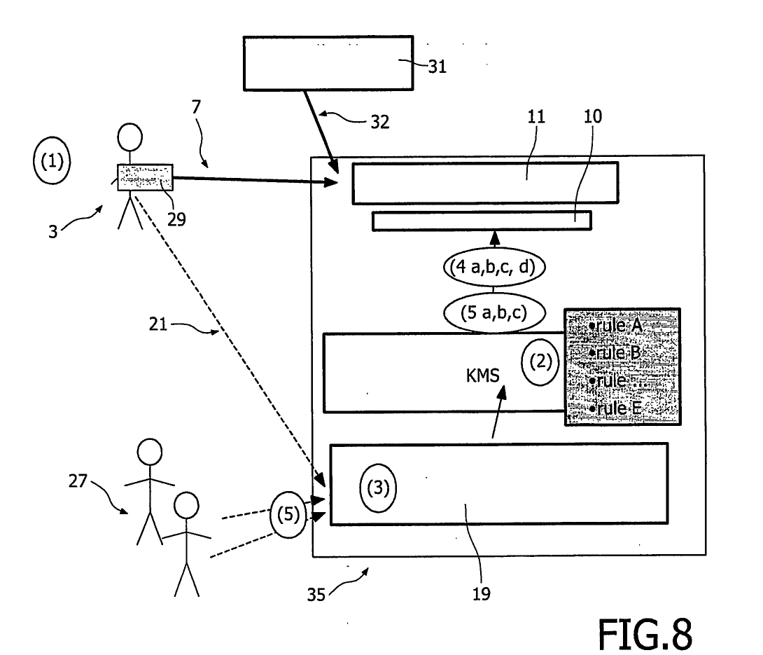

FIG. 8 a view of a situation in which several members of the hospital staff use the decentral unit.

With reference to FIG. 1, the principal structure of a possible total system 1 is described with a configuration management system 17 arranged centrally 33. The total system 1 has a monitor 11 which is allocated to the patient 3. Via a signal connection 7 the monitor 11 receives signals from further devices or sensors allocated to the patient 3.

FIG. 1 shows a further patient 5 to whom a further monitor 13 is allocated. Signals from this patient 5 are also supplied to the allocated monitor 13 via a signal connection 9. Both monitors are connected with the KMS 17 in a signal connection via a communication network 15. Furthermore the monitoring devices 11, 13 are connected with a location system 19 via a signal connection 23. Patients 3, 5 are connected via signal connections 21 with the location system 19. The hospital staff 27 are connected via a signal connection 28 with the location system 19. The location system 19 is in turn in signal connection with the KMS 17.

Depending on the actual situation detected, the monitors 11, 13 automatically adjust to a predetermined operating mode without action required by the hospital staff. The operating mode can depend on the location information, patient information and hospital staff information currently provided, also known as person identification information, and is also called the base setting. The different base settings allocated to the signal combinations are stored in a permanent memory of the medical device.

In particular the base setting is selected as a function of the place of use, the disease pattern of the patient currently monitored 3, 5, the task of the hospital staff 27 and where applicable the personal preferences of the staff 27, and the overall equipment configuration present to monitor the patient 3, 5 concerned.

For example on use of an ECG monitor in the intensive care station, a high resolution detailed signal display is required, while for monitoring in a nursing ward a less detailed information display is necessary. To operate the monitor to show less detailed information, an energy saving mode can be used.

Also if a specialist assesses the data displayed, a detailed display is required while for continuous monitoring mode reduced requirements are sufficient. If no hospital staff are present and hence there is no need to read the data, the display can even be switched off. Naturally this has no disadvantageous effect on maintaining the continuous patient monitoring and where applicable alarm triggering in critical situations.

Furthermore if a second monitor 12 is brought to the patient 3 or allocated to the patient as shown in FIG. 3, a suitable division of the display of all relevant patient signals can be made. This division of display can be established by the base settings present in the monitor memory. For example it can be established that the ECG view is always shown on the monitor arranged to the right of patient 3 and the blood oxygen values always on the monitor arranged to the left of patient 3. As well as spatial decision criteria it is also conceivable that the division is made according to which monitor is first allocated to the patient.

Such medical devices or systems with such medical devices are particularly suitable for use in hospitals. Medical devices in particular monitors can communicate with other devices by radio technology and transmit the data recorded. Wireless communicating devices allow a clearly increased mobility of patients and hospital staff by flexible use of the equipment at different locations with different patients and by different staff. This substantially increases the frequency of use and the number of different users. Automatic adaptation of the devices to individual applications makes the usage even more efficient. Automatic adaptation can however also be provided for devices communicating via a cable connection.

Automatic adaptation also saves working time and errors can be avoided when setting an operating mode. This simplified use increases the acceptance of such systems/devices. A comfortable and dynamic adaptation of the individual devices for each individual use and adaptation to the actual overall configuration in which a medical device is used is possible automatically.

As well as patient monitoring, mobile wireless medical equipment with automatic adaptation can also be used for mobile diagnostic devices or treatment devices.

Using the example of a monitor 11 in the form of a patient monitor, it is shown which criteria can be used to determine the automatic selection of the operating mode currently applied and hence the automatic configuration. The automatic configuration in each case is applied on start of monitoring of a new patient and dynamically during monitoring on the basis of the following criteria:
actual illness data and state of the patient concerned,

It may be provided to produce or record an ECG with 5 or 12 leads as a function of this data.
the hospital staff providing the treatment; this comprises
the general presence; e.g. hospital staff within visible radius of around 5 meters from a patient monitor
the specific task of the hospital staff;
a specialist or a nurse
personal preferences; e.g. display and arrangement on the monitor as a graph or value, etc.
the current usage point of the device; e.g. intensive care unit, emergency admission, nursing ward;
the use of further monitors also present at the same time.

A special system is described in detail below in which a central configuration management 17 is provided.

The numerals given in brackets below occur in complete circles in the figures.

(1) Each patient 3 is equipped with a CCC—Cableless Care Companion. As well as the collection and transmission of current vital parameters, the CCC device 29 contains information for patient identification.

The CCC 29 communicates via a radio interface 30 with other medical devices 14 in the vicinity and with a centrally arranged monitoring system 33.

(2) The central monitoring system 33 contains a KMS 17 for all associated mobile devices. The KMS 17 contains the following rule sets:

Rule A: Functionality of each monitor type as a function of hospital department;

Rule B: Display of medical data/vital parameters as a function of illness;

Rule C: Display of medical data/vital parameters as a function of hospital staff task (doctor or nurse);

Rule D: Display of medical data/vital parameters as a function of availability of further monitors connected;

Rule E: Personal preferences of individual users (doctors etc).

(3) Using the positioning system 19 also arranged centrally, the current position of all CCCs, monitors 11, 12, 13 and hospital staff is always measured; FIGS. 2-4,

(4) By means of the location system 19, the KMS 17 can automatically and continuously detect the position of each CCC 29, and location changes of devices 11, 12, 13 and persons 27 in its environment,

(5) Connection of a monitor 11, 13 with a patient by

a) setting the base functionality corresponding to the hospital department,

b) identification of a patient and determination of data/vital parameters to be displayed on the basis of the respective illness data retrieved from the central electronic medical records,

c) identification of further monitors in the vicinity of the patient which show current patient data,

Adjustment of the display according to rule (2) D.

d) start of continuous display corresponding to selection made in 5c).

(6) Dynamic adaptation of function/display:

a) Based on continuous location information (see (3), the KMS 17 establishes which hospital staff 27 are watching a particular monitor 11, 12, 13 and automatically adapts the device to the preferences of this person 27.

b) If several persons are present simultaneously (FIG. 4) either options for settings are offered or the setting is made according to a predefined priority list.

c) If there are no hospital staff 27 in the vicinity of the monitor 11, 12, 13, the display can be switched off automatically.

The influencing of these process steps is marked in FIGS. 2 to 4 with the numerals shown in brackets. In FIGS. 2 to 4 the patient data are stored on an electronic patient record 31.

FIGS. 1 to 4 differ in that the figure shows an overview of the total system with two patients as an example. In FIG. 2 the system is shown in relation to one patient. In the embodiment example shown in FIG. 3, two monitors 11, 13 are allocated to one patient 3. In the embodiment example shown in FIG. 4, the electronic patient record 31 acts on two monitors 11, 16, where only one monitor 11 is in signal connection with the CCC of patient 3. Here the monitor 16 can be used to display information from the electronic medical records 31.

A complete system is described below in which the configuration system 17 is provided in a decentrally arranged unit 35, 37 as shown in FIGS. 5 to 8.

(1) Each patient 3 is fitted with a Cableless Care Companion CCC 29. As well as collection and transmission of current vital parameters, the device contains information on patient identification and all current medical data.

The CCC 29 communicates via a radio interface 30 with other medical devices 11 in the vicinity.

(2) Each wireless monitor 11, in particular a patient monitor, contains a KMS 17.

The KMS 17 contains the following rule sets:
functionality of device 11 as a function of hospital department,
display of medical data/vital parameters as a function of illness picture,
display of medical data/vital parameters as a function of the task of the doctor/hospital staff 27,
display of medical data/vital parameters as a function of the availability of further connected monitors 39, FIG. 7,
personal preferences of individual users (doctors/patients).
   (3) By means of a location system 19 or by means of location signals received, each KMS 17 can automatically and continuously detect the actual position, and the vicinity of other medical devices 29 and vicinity of hospital staff 27. The hospital staff 27 carry corresponding wireless transmitters which are connected via a signal connection 28 with the location system 19.

Each KMS 17 is informed of the location change of the actual device via the location system 19.

Each KMS is informed via the location system 19 of the location change of equipment 11 and persons 27, 3 in its current environment.

(4) The connection of the monitor 11, 39 and patient 3 take place by

a) Setting the base functionality according to the hospital department,

b) Identification of the patient (via location-dependent position identification, distant-dependent position identification or via selection list); determination of data/vital parameters to be displayed on the basis of the current illness data which is either retrieved from the central electronic medical records or retrieved directly from the CCC of the patient concerned.

c) Identification of further monitors 39 in the vicinity of the patient 3 which show current patient data, and matching of the displays by rule (2)D.

d) Start of continuous display according to the selection in 4c).

(5) Dynamic adaptation of function and/or display:

a) Based on continuous location information (see 3), the KMS 17, 43 establishes which hospital staff 27 are present at a particular monitor 11, 39, and adjusts the device automatically to the preferences of this person.

b) If several persons 27 are present simultaneously, FIG. 8, either options for adjustment are offered or the adjustment takes place according to a predefined priority list.

c) If there are no hospital staff 27 in the vicinity of the monitor 11, 39, the display can be switched off automatically.

The embodiment examples shown in FIGS. 5 to 8 differ in that in FIG. 5 a decentral unit 35 with a monitor 11 is allocated to the patient 3. The various operating settings are stored in a memory 10. From this memory 10 the corresponding operating mode is taken as a function of the operating situation detected.

In the embodiment example shown in FIG. 6, the decentral unit allocated to the patient 3 is in signal connection with a further decentral unit 37. Via the decentral-unit 35 the further decentral unit 37 can be triggered for operation. In the embodiment example shown in FIG. 7 the decentral unit 35 is in signal connection 44 with a multiplicity of decentral units. Via these decentral units 35, 37 a communication network can be constructed. In the embodiment example shown in FIG. 8 several members of the hospital staff 27 are in simultaneous connection with the decentral unit 35 allocated to the patient 3.

### REFERENCE LIST

1 Total system
3 First patient
5 Further patient
7 Signal connection (first patient with monitor 11)
9 Signal connection (further patient with second monitor 13)
10 Memory
11 First monitor
13 Further monitor
14 Further medical devices
15 Communication network
16 Second monitor (first patient)
17 Configuration management system (KMS)
19 Location system
21 Signal connection (patient with 19)
23 Signal connection (monitor with 19)
25 Signal connection (15 with 17)
27 Hospital staff
28 Signal connection (27 with 19)
29 CCC
30 Radio interface
31 Patient records
32 Signal connection
33 Central monitoring system
35 Decentral unit
37 Further decentral units
39 Monitor
41 Operating setting
43 KMS
44 Signal connection between KMS
45 Location system

1. A medical device comprising a configuration management system (KMS) for automatic adaptation to current operating situations, wherein a memory allocated to the KMS stores operating settings which are allocated to signal combinations for operation of one or more medical devices, and wherein an operating mode of the KMS is specified in a signal connection with the medical device.

2. The medical device as claimed in claim 1, wherein the medical device is fitted with a receiver unit for wireless reception of signals.

3. The medical device as claimed in claim 1, wherein the signal combination comprises environment information comprising at least one of information on the location of the patient, the presence of hospital staff and further devices arranged in the vicinity of the patient.

4. The medical device as claimed in claim 1, wherein the signal combination comprises patient information.

5. The medical device as claimed in claim 1, a location system is in signal connection with the medical device.

6. The medical device as claimed in claim 1, wherein the KMS is part of the medical device.

7. The medical device as claimed in claim 1, wherein the KMS is arranged outside the medical device.

8. A process for operating a medical device to which a KMS is allocated, wherein as a function of the signals supplied to the KMS an operating mode is determined and the medical device triggered for operation according to the operating mode determined.

9. The process as claimed in claim 8, the various types of signal are location information, personal information and patient information.

10. The process as claimed in claim 9, wherein upon sensing patient data, a view on a display of a monitor is shown only on detection of staff identification and if no staff identification is detected for a predetermined period, the display is set to rest mode.

11. The process as claimed in claim 8, when pre-specified threshold values of sensed patient data are exceeded, the activity of the medical device is increased.

12. A system for use in a hospital, comprising a configuration management system (KMS) and a location system, wherein a current operating mode of medical devices in signal connection with the configuration management system is determined by the configuration management system from predetermined operating settings saved in a memory of the KMS.

13. The system of claim 12, wherein the current operating mode of the medical devices is determined by at least one of location of the patient, location of hospital staff, and location of surrounding medical devices.

14. The system of claim 12 further comprising a wireless device associated with a patient, wherein the wireless device provides patient information to the KMS.

15. A medical device comprising:
means for receiving one or more monitored patient parameters;
a display for displaying the one or more monitored patient parameters; and
a means for communicating with a configuration management system, wherein the configuration management system provides information pertaining to one or more display parameters.

16. The medical device of claim 15, wherein the configuration management system is located as part of the medical device.

17. The medical device of claim 15, wherein the configuration management system uses information regarding at least one of location of the patient, location of hospital staff, and location of surrounding medical devices to determine the display parameters.

18. The medical device of claim 15, wherein the configuration management system uses a priority table to establish which display parameters to use.

19. A medical device comprising:
means for receiving one or more monitored patient parameters; and
a display for displaying the one or more monitored patient parameters according to a set of display parameters;
wherein the display parameters are automatically determined by at least one of location of the patient, location of hospital staff, and location of surrounding medical devices to determine the display parameters.

20. The medical device of claim 19, wherein the display parameters are determined by the location of hospital staff, and wherein the medical device display is in a rest mode when no hospital staff are located within a predetermined distance of the medical device for a predetermined time interval.

21. The medical device of claim 19, wherein the display parameters are determined by the location of hospital staff and wherein the display parameters are different for different hospital staff members.

22. The medical device of claim 19, wherein the display parameters are further determined by a priority table.

23. The medical device of claim 19, wherein the display parameters are determined by the location of surrounding medical devices, and wherein the display parameters are shared by the medical device and at least one other medical device located within a predetermined distance from the medical device.

24. The medical device of claim 19 further comprising means for receiving patient information and wherein the display parameters are further determined by the patient information.
